(19) United States
(12) Patent Application Publication
(10) Pub. No.: US 2008/0010222 A1
(43) Pub. Date: Jan. 10, 2008

(54) MARKETING OPERATION SUPPORTING SERVER, PROGRAM AND ESTIMATE RETURNING METHOD

(75) Inventors: Keiichi NISHIYAMA, Kanagawa (JP); Kazuyoshi OHFUJI, Kanagawa (JP); Satoshi AKITA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kanagawa (JP)

(21) Appl. No.: 11/773,899

(22) Filed: Jul. 5, 2007

(30) Foreign Application Priority Data
Jul. 7, 2006 (JP) 2006-188025
Mar. 15, 2007 (JP) 2007-129216

(51) Int. Cl. G06Q 30/00

(52) U.S. Cl. 705/400

(57) ABSTRACT

Marketing operation supporting system wherein a response for estimation may be returned as plural factors including circumstances of the client and the order receiving side and the future prospect. A marketing operation supporting server 30 includes a DB for correction 42 in addition to a DB for estimation 41 that calculates a prevailing price based at least on product specifications and on product quantities. The DB for correction 42 has set in it correction points associated with contents of a plurality of correction items not influencing the prevailing price. These correction items are items of attributes proper to matters relating to the estimation request. The marketing operation supporting server 30 returns a response for estimation at a special price corrected from the prevailing price using correction points associated with at least two correction items.

### RELATED APPLICATIONS

This application is based upon and claims the benefits of the priorities of Japanese patent application No. 2006-188025, filed on Jul. 07, 2006 and Japanese patent application No. 2007-129216, filed on May 15, 2007, the disclosures of which are incorporated herein in their entirety by reference thereto.

### FIELD OF THE INVENTION

This invention relates to a marketing operation supporting server, a program and a method for returning an estimate as response. More particularly, this invention relates to a marketing operation supporting server for receiving a request for estimation via, e.g., the Internet and for automatically returning an estimate as response, a program and a method for returning the estimate using a server.

### BACKGROUND OF THE INVENTION

Recently, the method for returning an estimate using the Internet has developed extensively. For instance in the field of the semiconductor product, Patent Document 1, JP Patent Kokai Publication No. JP-P2001-326151A discloses a system for manufacturing a semiconductor integrated circuit in which a client is connected to a data management center, a designing center and a fabrication center on the side of a manufacturer via the Internet, and in which the manufacturer may proceed with fabrication of an ASIC (Application Specific Integrated Circuit) as communication is kept between the client and the manufacturer. It is stated in paragraph

of the Publication that the data management center is connected to a cost/number of days database and a reservation database and has the function of advising the client of the relative busy state of production lines, cost and the number of days, in response to an order for ASIC from the client.

Recently, the techniques for developing system LSIs at a low cost and within a short time period, by assembling plural chips, inclusive of a chip for ASIC, into one package, such as SIP (System in Package) or MCP (Multi Chip Package), have become prevalent, too. In the present application, the ASIC, SIP and MCP are collectively named ‘custom semiconductors’. In this connection, prompt and highly accurate responses to particular inquiries from the clients are becoming more important in marketing operation activities. For example, there is stated a similar situation in Patent Document 2 which has disclosed a supporting system in receiving orders for custom products, such as printed wiring boards.

The supporting system in receiving orders for custom products, disclosed in Patent Document 2, improves the work flow in a company at each stage of a business meeting, in particular the work flow concerning price matching or specifications matching. However, there is no mention made therein of an automatic estimation system.

There have also been proposed a wide variety of automatic estimation systems for returning a response to inquiries from marketing operation staff members or clients in keeping with individual matters. For example, Patent Document 3 discloses a sale price determining system for determining sale prices based on conditions for negotiations shown in sale guideline describing files, including client's purchase history, cumulative purchasing amounts, vendor's inventory status or next delivery periods. It is noted that the system of Patent Document is not relevant to custom merchandise.

### [Patent Document 1]

JP Patent Kokai Publication No. JP-P2001-326151A

### [Patent Document 2]

JP Patent Kokai Publication No. JP-P2003-150828A

### [Patent Document 3]

JP Patent Kokai Publication No. JP-P2002-149945A

### SUMMARY OF THE DISCLOSURE

The following analyses are given by the present inventors. Meanwhile, the disclosures of Patent Documents 1 to 3 are incorporated by reference into the present specification.

The automatic estimation response function of Patent Document 1 may allow reducing time and labor in returning the estimate as response. However, there lacks assurance as to offering the specifications, prices and the delivery periods that may be satisfactory for the user. It is of course possible to set fundamental conditions, such as prevailing prices or reference delivery periods, by specifications or quantities. However, in the on-demand manufacturing business, these conditions may become an ultimate response only on extremely rare occasions as mentioned in Patent Document 2. That is, proposals of detailed specifications, delivery periods or prices for the clients need to be made as background circumstances of individual inquiries, taking into account such as the circumstances of the client and the order-receiving side and/or the future prospects.

In particular, in a semiconductor manufacturing industry, it is an important factor to depreciate tremendous cost invested for production lines and, to this end, to keep their capacity utilization rate as high as possible, in order to ensure benefits of the business. It is also important to equalize designing line loads in order to achieve the product quality or the delivery period requested by the client. However, with the automatic estimating function of Patent Document 1 or 3, it is not possible to take these factors into account in order to offer reasonable prices.

In a first aspect, the present invention provides a marketing operation supporting server for automatically returning a response to an estimation request from a client terminal. The server comprises a database for estimation that calculates a prevailing price based at least on the specifications and quantities of a product, and a database for correction having set therein correction points associated with contents of a plurality of correction items not influencing the prevailing price. The correction items are items of attributes proper to matters relating to the estimation request. A response for estimation is made at a special price which has corrected the prevailing price using correction points associated with at least two correction items. (Mode 1)

In more detail, the marketing operation supporting server includes a calculating unit that calculates a prevailing price, based on contents entered by the request for estimation, by having reference to the database for estimation, an extracting unit that extracts correction points associated with at least two correction items, and correcting the prevailing price, by having reference to the database for correction, and a response unit that sends the estimate as response at a special price corrected from the prevailing price. This makes it possible to return an estimate as response as corrected by plural items for correction determined by taking into account the background circumstances, including client's or vendor's circumstances, and the future outlook, apart from elements influencing the prevailing price, such as specifications or quantities.

In a second aspect, the present invention provides a program that may be executed by a marketing operation supporting server provided on a network. The marketing operation supporting server automatically returns a response to a request of estimation from a client terminal. The program includes processing of referencing a database for estimation, based on contents entered with the request for estimation, to calculate a prevailing price; and processing of referencing a database for correction having set therein correction points associated with contents of a plurality of correction items not influencing the prevailing price. The correction items are items of attributes proper to matters relating to the estimation request. The program also includes processing of extracting correction points associated with at least two of the correction items and correcting the prevailing price based on the extracted correction points, and processing of sending a response for estimation at an as-corrected special price to the client terminal.

In a third aspect, the present invention provides a method for returning a response for estimation by a marketing operation supporting server provided on a network method. The marketing operation supporting server automatically returns a response for estimation to a request for estimation from a client terminal. The method comprises a step of the marketing operation supporting server referencing a database for estimation, based on contents entered with the request for estimation, to calculate a prevailing price; and a step of the marketing operation supporting server referencing a database for correction having set therein correction points associated with contents of a plurality of correction items not influencing the prevailing price, extracting correction points associated with at least two of correction items, and correcting the prevailing price based on the extracted correction points. The correction items are items of attributes proper to matters relating to the estimation request. The method further comprises a step of the marketing operation supporting server sending a response for estimation at an as-corrected special price to the client terminal.

The meritorious effects of the present invention are summarized as follows.

According to the present invention, the price may be offered under consideration of plural factors (price correction items), such as the depreciation rate of production lines or loads on the design line. Hence, loss of order receipt (chance loss) may be reduced, while more appropriate prices may be offered for the client, thus allowing both the client and the vendor to select proper merchandise.

### BRIEF DESCRIPTION OF THE DRAWINGS

FIG. 1 is a schematic view showing the constitution of a first exemplary embodiment of the present invention.

FIG. 2 is a schematic view showing the concept of product selection in the course of formulation of an estimate by a marketing operation supporting server according to a first exemplary embodiment of the present invention.

FIG. 3 is a diagram showing an example of a unit product price correction table stored in a DB for correction.

FIG. 4 is a diagram showing a development cost correction table stored in the DB correction.

FIG. 5 is a diagram showing a response delivery period correction table stored in the DB for correction.

FIG. 6 is a diagram showing another example of a unit product price correction table (correction by the depreciation rate of a production line) stored in the DB for correction.

FIG. 7 is a flowchart for illustrating the operation of the first exemplary embodiment of the present invention.

FIG. 8 is a diagram for illustrating an effective setting example for the respective tables of the DB for correction.

FIG. 9 is a diagram similar to FIG. 8 for illustrating an effective setting example for the respective tables of the DB for correction.

FIG. 10 is a diagram showing an example of a list style, demonstrated on a client terminal, in a second exemplary embodiment of the present invention, in the order of the increasing unit product price.

FIG. 11 is a diagram showing an example of a list style, demonstrated on a client terminal, in the second exemplary embodiment of the present invention, in the order of the increasing power consumption.

FIG. 12 is a diagram showing an example of a list style, demonstrated on a client terminal, in the second exemplary embodiment of the present invention, in the order of the increasing length of the delivery periods.

FIG. 13 is a diagram showing an example of a list style, demonstrated on a client terminal, in the second exemplary embodiment of the present invention, with the proviso that the request specifications be strictly respected.

FIG. 14 is a schematic view showing the constitution of a third exemplary embodiment of the present invention.

FIG. 15 is a flowchart for illustrating the operation of a third exemplary embodiment of the present invention.

FIG. 16 is a flowchart showing substitution from FPGA to ASIC.

FIG. 17 is a schematic view showing a specified example of formulation of a FED estimate.

### PREFERRED MODES OF THE INVENTION

In the present invention, the following modes are preferred.

The estimation request may execute substitution from one custom semiconductor product type to another custom semiconductor product type. (Mode 2)

In making estimation to the other custom semiconductor product type, the cost reducing effect for a client, attendant on change from the one custom semiconductor product type to the other custom semiconductor product type, may be automatically offered. (Mode 3)

The followings may be further comprised a database of detailed designing sections that executes detailed designing of the other custom semiconductor product type; wherein at least one of the detailed designing sections is offered responsive to a request for introducing a detailed designing section from the client terminal. (Mode 4)

The database for correction may have set therein a depreciation rate of a production line associated with a custom semiconductor product type, and a correction point conforming to the depreciation rate; wherein correction may be made by the correction point conforming to the depreciation rate of a production line associated with a custom semiconductor product type relating to the request for estimation. (Mode 5)

The database for correction may have set therein a relative busy state of a designing line associated with a custom semiconductor product type, and a correction point conforming to the relative busy state; wherein correction may be made by the correction point conforming to the relative busy state of a designing line associated with a custom semiconductor product type relating to the request for estimation. (Mode 6)

The database for correction may have set therein a plurality of correction items and correction points therefor; wherein if at least one of the correction points exceeds a preset threshold value, only correction by the correction point may be done to calculate the special price. (Mode 7)

A limit value of pricing correction by the database for correction may be set. (Mode 8).

Relative strictness in respecting a preset one of the items may be designated in the estimation request; the correction points on the database for correction may be set so that a price offered will be cheaper as the relative strictness in respecting the preset item becomes lower; and correction may be made with the relative strictness requested in respecting the preset item. (Mode 9)

The marketing operation supporting server may further comprise: means for accepting an input of an upper limit of a presupposed price at the estimation request; wherein if, after referencing the database for estimation and the database for correction, a response for estimation, which will satisfy the request specifications designated in the request for estimation and the upper limit of the presupposed price, cannot be returned, re-entries in one or more items that are specified in the request for estimation and that may be made more lenient are requested to proceed to a re-response. (Mode 10)

The marketing operation supporting server may further comprise: an accepting unit that accepts inputting of an upper limit of a presupposed price and inputting of the relative importance of an item included in the request for estimation; wherein a plurality of responses for estimation, in which items with high relative importance have been respected and items with low relative importance have been changed, are formulated, by referencing to the database for estimation and to the database for correction. (Mode 11)

For the request for estimation, the one custom semiconductor product type and the other custom semiconductor product type may be a FPGA and an ASIC, respectively. (Mode 12)

The marketing operation supporting server may further comprise: a business matter extraction unit that extracts the request for estimation, that is to be individual business matters (dealing items), based on the contents of the request for estimation, and for notifying a preset terminal of a staff member in charge of the business matters of the extracted request for estimation along with the contents of the response offered to the client terminal. (Mode 13)

Correction points that are in keeping with client classification that is based on the importance attached to clients, may be set in the database for correction; and correction may be made using correction points of the client class under which comes the client who has made the request for estimation, whereby a price differentiated from the price for other client classes may be offered. (Mode 14)

Correction points that are in keeping with strategic importance of product types may be set in the database for price correction; and a price adjusted using the correction point of the product type in the request for estimation may be offered. (Mode 15)

The database for correction may include a table for correcting a unit product price, having stored therein correction points referenced at correction of a product unit price, a table for correcting the development cost, having stored therein correction points referenced at correction of the product development cost, and a table for correcting a response delivery period, having stored therein correction points referenced at correction of the response delivery period; and correction may be made for the matters relating to the request for estimation, in accordance with the correction points as found from the tables, to correct the unit product price, the product development cost and the delivery period to enable a response to be returned. (Mode 16)

### First Exemplary Embodiment

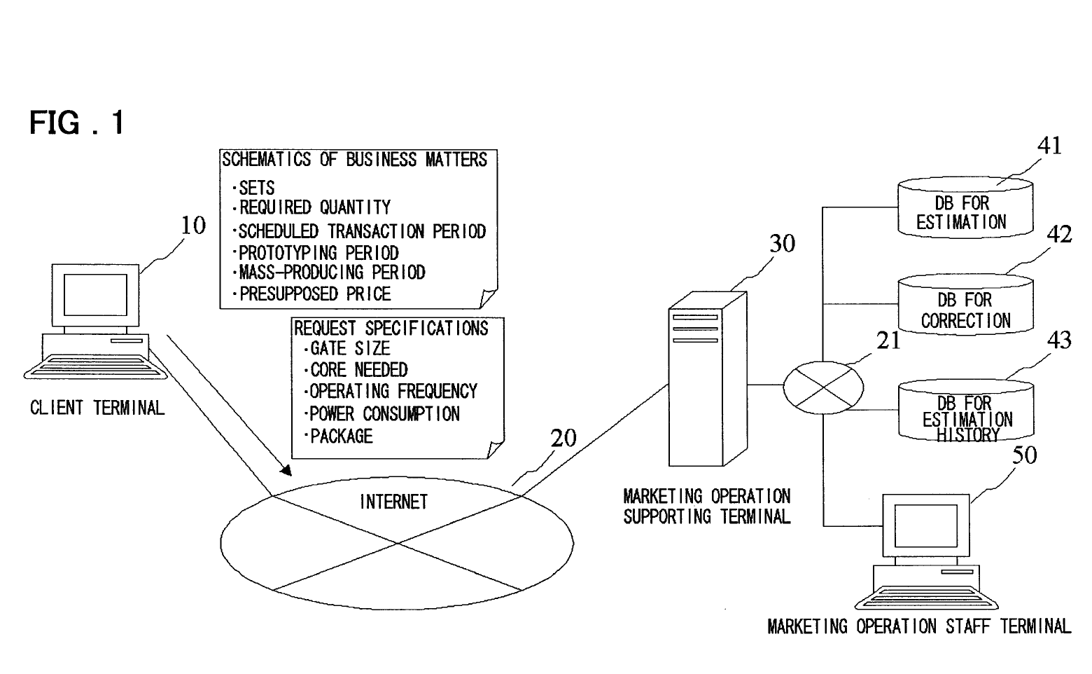

A preferred mode for carrying out the present invention is now described in detail with reference to the drawings. FIG. 1 depicts the constitution of a first exemplary embodiment of the present invention. There are shown in FIG. 1 a client terminal 10 and a marketing operation supporting server 30, both of which can be connected to the Internet 20. There are also shown a database for estimation 41, referred to below as DB for estimation, used as basis for price estimation, a database for correction 42, referred to below as DB for correction, an estimation history database 43, referred to below as DB for estimation history, and a marketing operation staff terminal 50. The databases 41 to 43 and the marketing operation staff terminal 50 are connected to an intranet 21.

The client terminal 10 is an information processing device, such as personal computer, which may access the marketing operation supporting server 30 via the Internet. The client terminal 10 is provided with a browser that allows a user to fill in a form for estimation, sent from the marketing operation supporting server 30, and to browse the results of the estimation.

The marketing operation supporting server 30 is an information processing device that makes up an automatic estimation system for a custom LSI, and sends a form for estimation to the accessing client terminal 10 for a client to enter schematics of business matters and request specifications concerning the custom LSI. The marketing operation supporting server 30 references the DB for estimation 41 and the DB for correction 42, based on the contents entered in the form for estimation, to generate and send the results of the estimation which will meet the request specifications, costs (unit price or development cost) or the period for delivery (that for prototyped products and that mass-produced products) as specified by the client terminal 10.

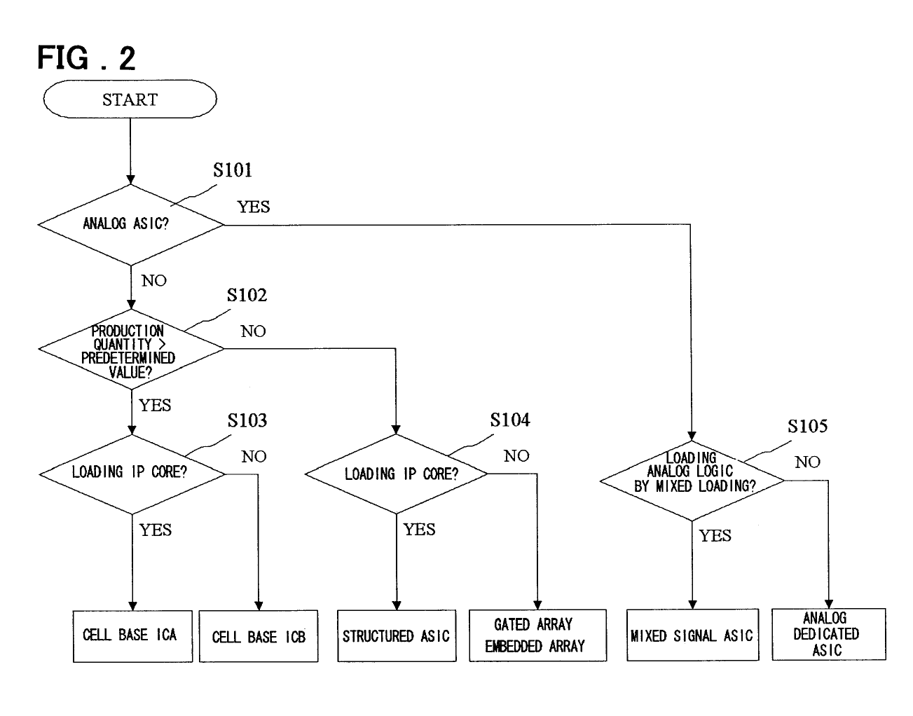

FIG. 2 shows the concept of product selection in the estimate producing process by the marketing operation supporting server 30. For example, if the production quantity exceeds a preset value stored in the DB for estimation 41, a cell base IC, which allows reducing the total cost, is selected. Based on the request specifications, the chip size, package and corresponding prices are determined, using data of, for example, a decision map stored in the DB for estimation 41. If conversely the production quantity is estimated to be small, a gate array or a structured ASIC, which allows reducing development costs, is selected. In the DB for estimation 41, there are also stored data on the load of a development section or on the operating status of the production line, which will allow finding the period for delivery.

In the DB for correction 42, there are stored plural sorts of tables, such as a table for correcting unit prices of products, a table for correcting the developing cost, or a table for correcting the response delivery period. A plural number of each of these tables is provided to make it possible to change the setting contents in accordance with the time of development of the product, the estimation of which has been requested. Also, the table for correcting unit prices of products, the table for correcting the developing cost and the table for correcting the response delivery period, are periodically checked by supervisors or superintendents and updated as necessary in accordance with the state of transactions with the clients, the environment for the business in question or management strategies of the business organization in question.

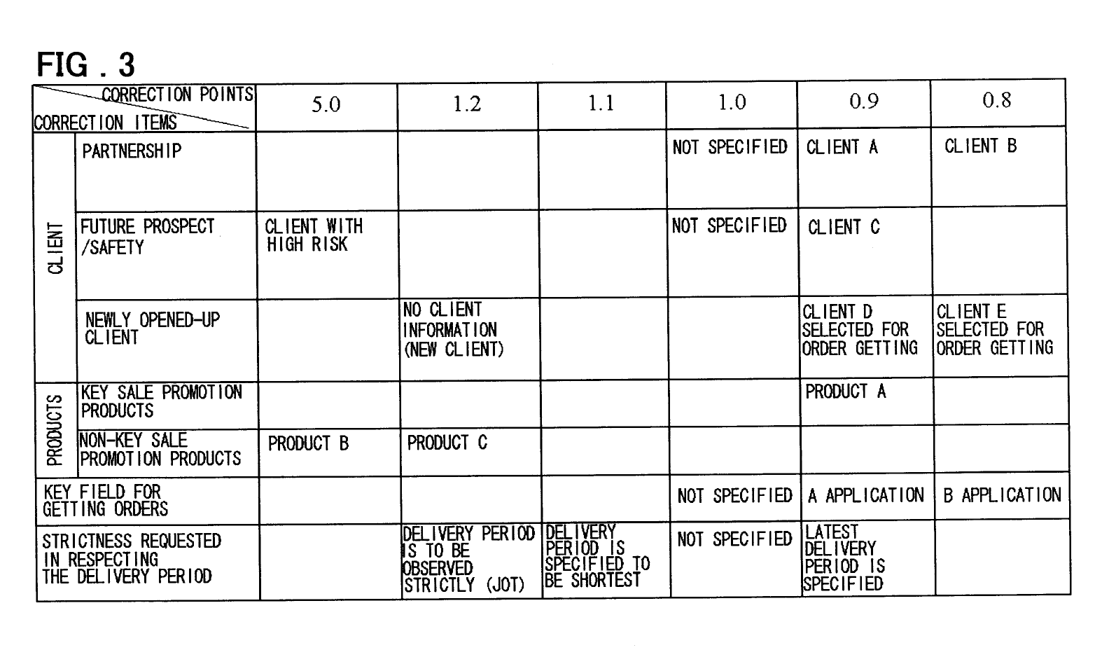

FIG. 3 shows a table for correcting unit prices of products, to which reference is had at an inquiry during a given quarter of a year. With the table for correcting unit prices of products, it is possible to obtain price correction points (or scores) based on cells of strategically important items (correction items) as selected from entry items of the form for estimation. In the example shown in FIG. 3, correction points lower than 1.0 are accorded to clients D and E selected for promotion for getting orders. On the contrary, correction points much higher than 1.0 (5.0) are accorded to the clients with high risk. Also, with the case of FIG. 3, different correction points are set depending on the client's relative strictness in the observation of the delivery period, where an inquiry with higher lenience in the observation of the delivery period is prioritized. Stated differently, the correction points are set so that the asking price will be lower the less stringent the degree of request of observation of the delivery period on the part of the client. It should be noted that, as a general rule, the clients' attributes or the items of the delivery period request of FIG. 3 do not influence the price. That is, the above items are not used in calculating the prevailing price.

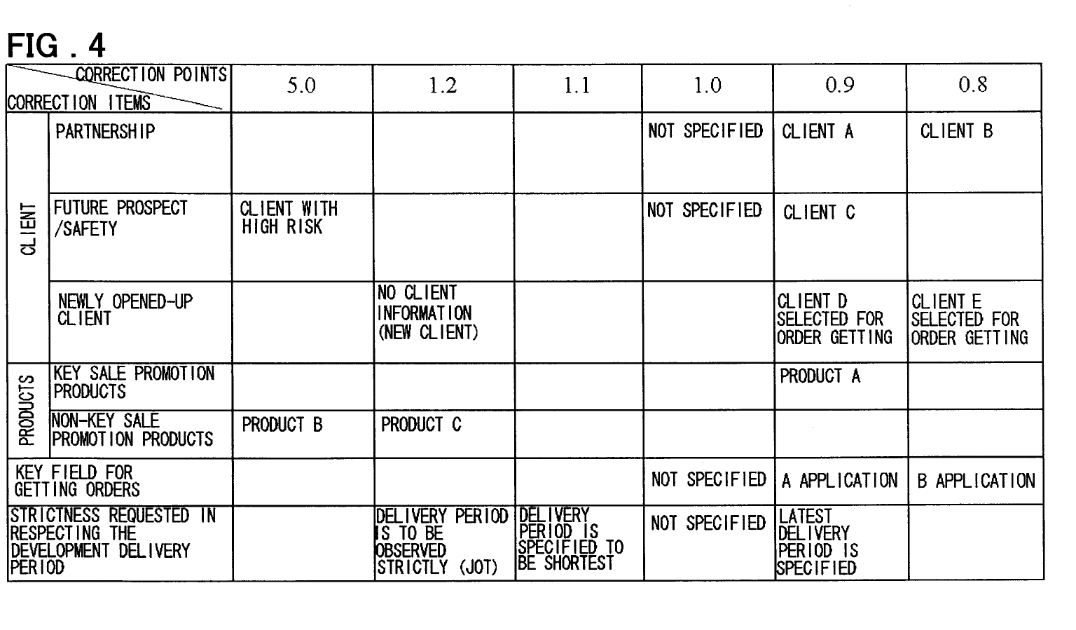

FIG. 4 shows a table for correcting the developing cost to which reference is made at an inquiry during a given quarter of a year. With the table for correcting the developing cost, it is possible to obtain correction points that correct the development cost, based on cells for strategically important items (strategic items) out of the input items in the aforementioned form for estimation. In the case of FIG. 4, to offer more attractive prices for the clients selected for promotion for getting orders D and E in order to get new orders, correction points lower than those of the aforementioned table for correcting unit prices of products are accorded to those clients. Also, the correction point lower than that of the table for correcting unit prices of products is accorded to a product A, which is a key sale promotion merchandise determined to be important from the viewpoint of management strategy. If the degree of request for strict observation of the delivery period is higher, the value of the cost correction point is higher. In this case, it may again be said that the correction point is set so that, the lower the degree of severity in the request for observation of the delivery period, the lower is the offering price.

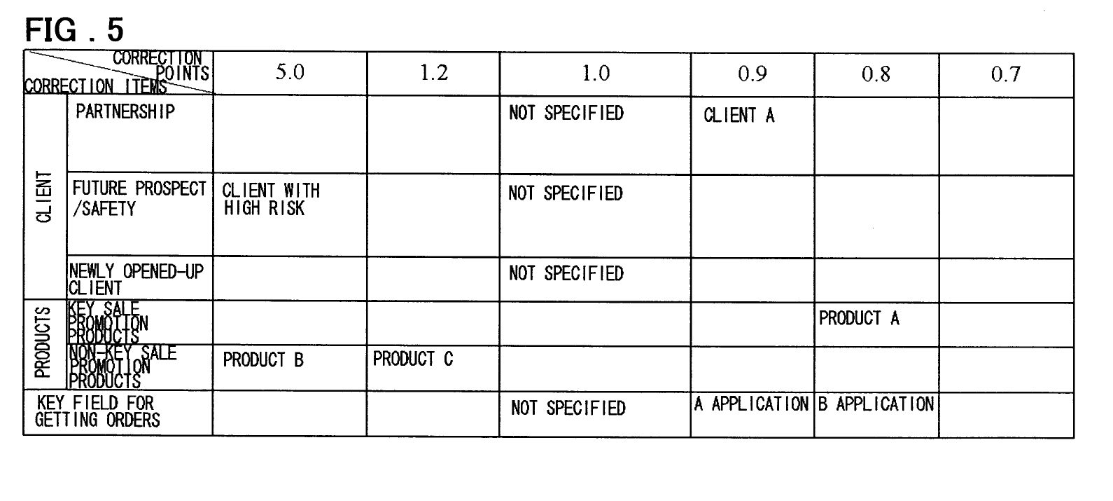

FIG. 5 shows a table for correcting the table for correcting the response delivery period, to which reference is made at an inquiry during a given quarter of a year. With the table for correcting the delivery period, it is possible to obtain correction points that correct the response delivery period, based on cells for strategically important items (strategic items) out of the input items in the aforementioned form for estimation.

In the cases of FIGS. 3 to 5, there are provided cells for the correction point=5.0. This is for an inquiry for which an order is desirably evaded in view of the state of order receipts or from seasonal reasons.

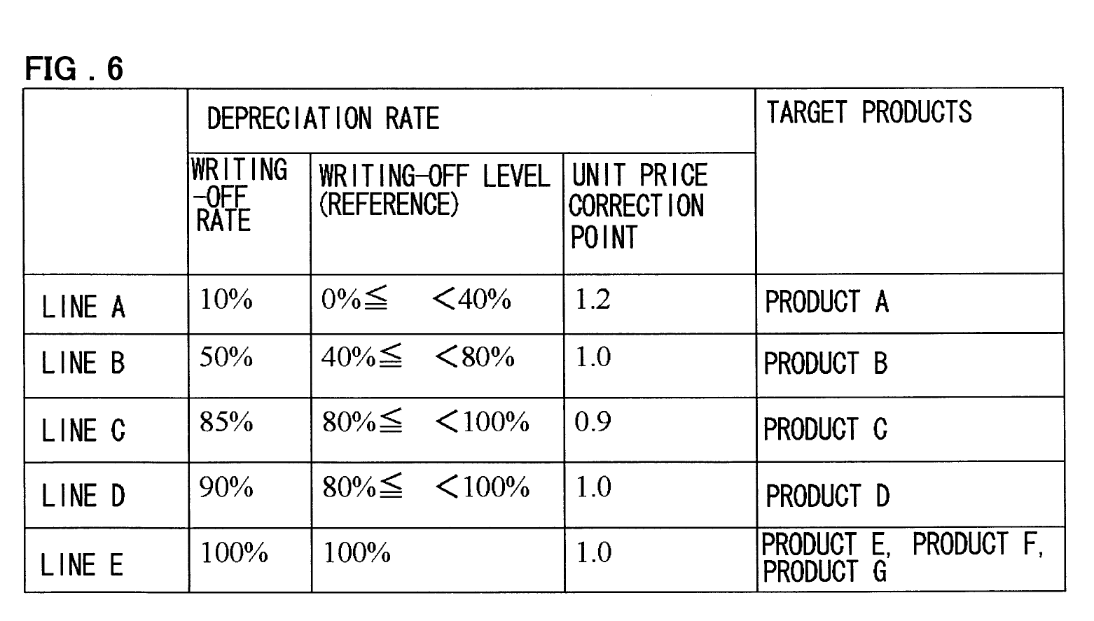

FIG. 6 shows a cost correction table, distinct from the table for correcting unit prices of products of FIG. 3, for correcting the price from the standpoint of the depreciation rate of production lines. Referring to FIG. 6, correction points are set for correcting the unit price of the product in accordance with the depreciation rates of lines A to E associated with products A to G.

The production lines here mean lines for a XX nm (nano-meter) process for a product in question. In case these lines are in plural plants, there are cases where these lines have different depreciation rates. Usually, price correction may be determined by taking into account a main plant supposed to be responsible for a production of a product in question. It is sufficient if the correction point ultimately reflected by a product is determined. The concept of price correction from the standpoint of the depreciation rate of the production line is now described.

The customary process is to set the prevailing (or several) prices of products based on the result of the prime cost calculations of the products. The depreciation rate of equipment is an important factor in calculating the prime cost. In the semiconductor manufacturing industry, where the equipment cost is high, the cost from this standpoint is naturally reflected in the prevailing price. The correction points shown in FIG. 6 are aimed at more strategically correcting the price with the foregoing taken into account. The correction points are set to specified values by taking various factors into account. These values may be found by a preset equation, in keeping with the actual depreciation rate of a production line, or may be set in accordance with comprehensive business strategies, as later described, or from the standpoint of managerial strategies. Hence, the correction points, entered in FIG. 6, may more precisely be termed strategic unit price correction points that take the depreciation rate of the production line into account. From this standpoint, the correction points may be said to be items not used in calculating the prevailing price.

The depreciation rate of production equipment is already reflected in the calculations of the prime cost, which form the basis for calculating the prevailing price. If this prevailing price is used as is, in other words, if no correction is made from the comprehensive business strategies or strategic standpoint, the correction points are all 1.0. In contrast, for a line A with a depreciation rate of 10%, a correction point of 1.2 is accorded, from the consideration that the line A is plagued with unforeseen troubles and is risky. On the other hand, the correction point of 0.9 is accorded from the consideration that it is strategically desirable to raise the rate of utilization of the line C.

The foregoing refers to an example of price correction from the standpoint of the depreciation rate of the production line. However, even if the depreciation rate of a production line is low, the asking price may be low in case the line permits mass production in stability. On the other hand even if the depreciation rate of a production line is high, the asking price may be high in case the line permits mass production in stability. On the other hand, it is possible to set a high or low asking price for a product associated with a particular production line.

The DB for estimation history 43 is a database for recording estimated contents, actually offered to the client, using each table stored in the DB for correction 42.

The marketing operation staff terminal 50 is an information processing device, such as a personal computer, of a marketing operation staff member for receiving a notification of business matters, the business meeting for which need to be proposed from the marketing operation supporting server 30. Meanwhile, the contents of the response to the client, recorded in the DB for estimation history 43, are annexed to the notification of the business matters in need of business meeting, as will be described subsequently.

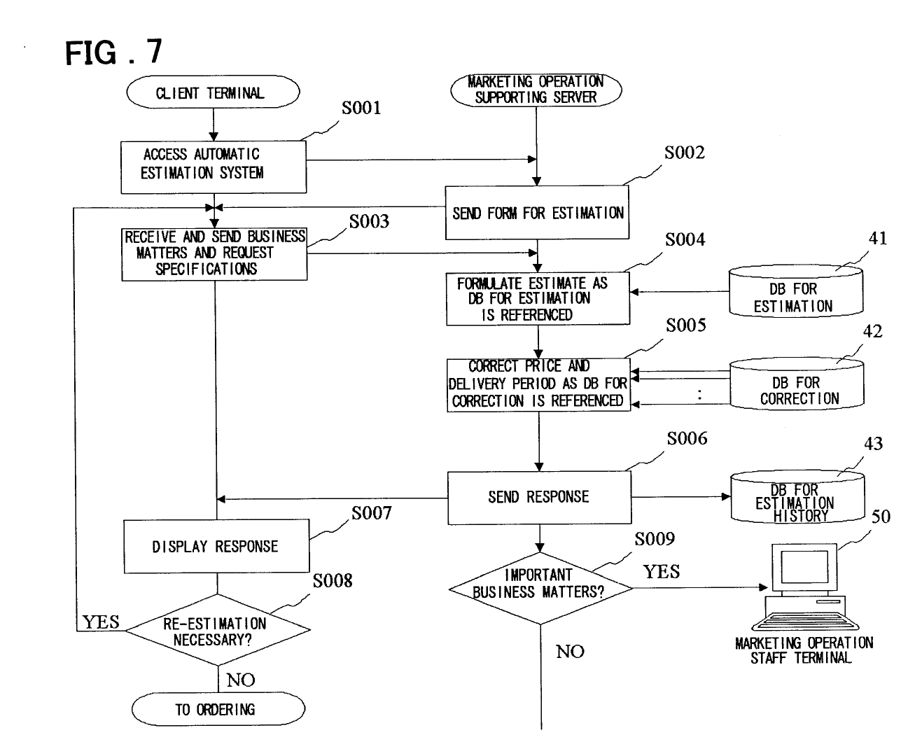

The operation of the present exemplary embodiment is now described in detail with reference to the drawings. FIG. 7 depicts a flowchart showing the overall operation of the present exemplary embodiment. Referring to FIG. 7, if the client terminal 10 accesses an automatic estimation system, as provided by the marketing operation supporting server 30 (step S001), the marketing operation supporting server 30 sends an estimation form (or format) to the client terminal 10 (step S002).

The client terminal 10 herein means an authentic client terminal authorized through the client examination. Like customary systems, the present automatic estimation system has a variety of functions for assuring system safety to eliminate illegal actions on the system operations by malignant third parties. These functions include client examination, authorization systems, firewalls, transactions by passwords and client certification each time an inquiry is made. However, such is not relevant to the present invention and therefore the corresponding description is dispensed with. It goes without saying that certification that the client terminal is an authentic client (authorization) has already been made before sending the estimation form.

If, in the client terminal 10, the user has entered the outline of the business matters or request specifications, in accordance with input items of the form for estimation (step S003), the marketing operation supporting server 30 references the DB for estimation 41 to formulate an estimate (step S004).

At a time point of step S004, the correction by strategic items, with the use of the DB for correction 42, has not been made. Hence, the same contents of the estimation are formulated if the contents of the business matters (merchandise objects) and the request specifications are the same.

The marketing operation supporting server 30 sequentially references each table stored in the DB for correction 42 and correction points of the respective items of correction to correct the prices (unit prices of products and development cost) as found in step S004 and the delivery period (step S005).

Several typical methods for correcting the price or the delivery period from the strategic standpoint, using the above correction points, will now be described.

Case 1, in which a request for estimation of a unit price of a product A is received from a client A, for a key field for order getting (B-application program), with no designation for strict observation of the delivery period, and case 2, in which a request for estimation of a unit price of a product C, with an application program with no designation of the key sale promotion field, and with no designation for strict observation of the delivery period, are now scrutinized. For these cases, price correction may be made using the table for correcting unit prices of products of FIG. 3 and/or the table for correcting the price based on the depreciation rate of the production line of FIG. 6.

(1) The contents of the request for estimation are fitted in the table for correcting unit prices of products of FIG. 3. The contents are multiplied with correction points of the respective items to give corrected prices.

Referring to FIG. 3, since the correction for the client is 0.9 (client A), correction for product is 0.9 (product A), correction for key field for getting orders is 0.8 (application program B) and the correction for the degree of strictness of observation of the delivery period is 1.0 (no designation), for the case 1, these coefficients are multiplied with one another to give a value of 0.65 which is used as a value for price correction (0.9×0.9×0.8×1.0=0.648; the third place below the decimal point has been approximated).

For case 2, the coefficients are similarly multiplied with one another to give a value of 6.0 which is used as a value for price correction (5.0 (client with high risk)×1.2 (merchandise of non-sale-promotion)×1.0 (no designation)=6.0).

It is also desirable to set upper and lower limits (range) for the values for price correction to avoid the break-even situation or an excessively high offering price ascribable to excessive price correction. For example, if the range between the upper and lower limits of the values for price correction is set to 0.6 to 10.0 and the result of the multiplication exceeds 10.0, the value for price correction is set to the upper limit value of 10.0. Likewise, if the result of the multiplication is less than 0.6, the value for price correction is set to the lower limit value of 0.6.

(2) The contents of the request for estimation are fitted in the table for correcting unit prices of products of FIG. 3. The value for price correction is obtained using only the correction points of the designated items (prioritized items).

For example, if the correction for clients and correction for fields of key sale promotion have been selected as prioritized items, the value for price correction for case 1 is 0.72 (0.9 (client A)×0.8 (application program B)=0.72).

For case 2, the value for price correction is 5.0 (5.0 (client with high risk)×1.0 (no designation)=5.0).

In the above cases, two prioritized items are used. However, the number of the prioritized items may be only one, where the correction point of the prioritized item itself becomes the value for price correction. The number of the prioritized items may also be three or more, where upper and lower values may again be set for the value for price correction, as described in (1) above.

(3) The contents of the request for estimation are fitted in the table for correcting unit prices of products of FIG. 3. The correction point which is the largest value or the smallest value is used as the value for price correction, where the value with the larger absolute value is so used.

For case 1, for instance, where the correction for the field of key sale promotion is smallest or 0.8 (application program B), the value for price correction is 0.8.

For case 2, where the client correction is maximum and equal to 5.0 (client with high risk), the value for price correction is 5.0

In the above examples, the absolute values of the correction points are simply compared to one another. Alternatively, it may be determined to use the maximum value or the minimum value based on the value of the correction point of a particular item. For example, when the client correction point is less than 1.0, it is possible to select the smallest of the values of the remaining correction points. In similar manner, when the client correction point exceeds 1.0, it is points.

(4) Combination of the price corrections of (1) to (3) and the price correction by the price correction tables by the depreciation rate of the production line of FIG. 6.

For example, if, in case the value of price correction of 0.65 is obtained by price correction (1) in the above case 1, the correction point 1.2 (product A) is further obtained from FIG. 6, the ultimate value of price correction is 0.65×1.2=0.78.

Also, if the value of price correction of 6.0 is obtained by price correction (1) in the above case 2, and the correction point 0.9 (product C) is further obtained from FIG. 6, the ultimate value of price correction is 6.0×0.9=5.4.

As described above, in product sorts with emergent development resources, correction points of items relevant to the resources of development may be prioritized, and the correction points of the remaining items may then be used to calculate the value for price correction. It is of course possible not to correct the price by the line depreciation rate for such matters where development is costly and time-consuming and application of the line depreciation rate is difficult for reasons on time.

It is similarly possible to apply the correction tables of FIGS. 4 to 6 to development costs and the delivery periods to offer a strategic response. Meanwhile, the numerical values of the correction points, shown above and in the drawings, are merely illustrative and may be changed without limitations.

Still referring to FIG. 7, the marketing operation supporting server 30 sends the contents of the estimate, having corrected the price (unit price of the product and development cost) and the delivery period, to the client terminal 10. The marketing operation supporting server also causes the same contents to be stored in the DB for estimation history 43 (step S006).

The client terminal 10 displays the contents of the estimate received from the marketing operation supporting server 30 (step S007). If the user is satisfied with the result of the estimate, processing for placing an order is carried out with the contents. Although the processing may be carried out using an E-mail or facsimile, it may also be carried out using a separate function of receiving an order if such function is provided in the marketing operation supporting server 30.

If conversely the user is not satisfied with the contents of the estimate, it is possible to obtain a second estimate by the user again by changing the matters entered in items of the form for estimation to partially change the schematics of the business matters or the request specifications (YES at step S008). This second estimation is corrected by referencing the DBs for correction 42, and hence has been adjusted in line with the status or the strategic principle of the vendor of the custom LSI.

If the contents of the estimate, formulated in step S007, are the business matters of large size or an inquiry pertinent to the key sale promotion product, or otherwise meets the condition determined by the vendor as being the important business matter, the marketing operation supporting server 30 advises the marketing operation staff terminal 50 of that effect along with the offered contents of the estimate (step S009). The marketing operation staff is able to confirm the contents of the estimate it has been advised of and to begin positive activities for receiving an order. It is of course possible to correct the criteria of judgment as to the importance of the business matters as necessary and keep the so corrected criteria of judgment in the marketing operation supporting server 30.

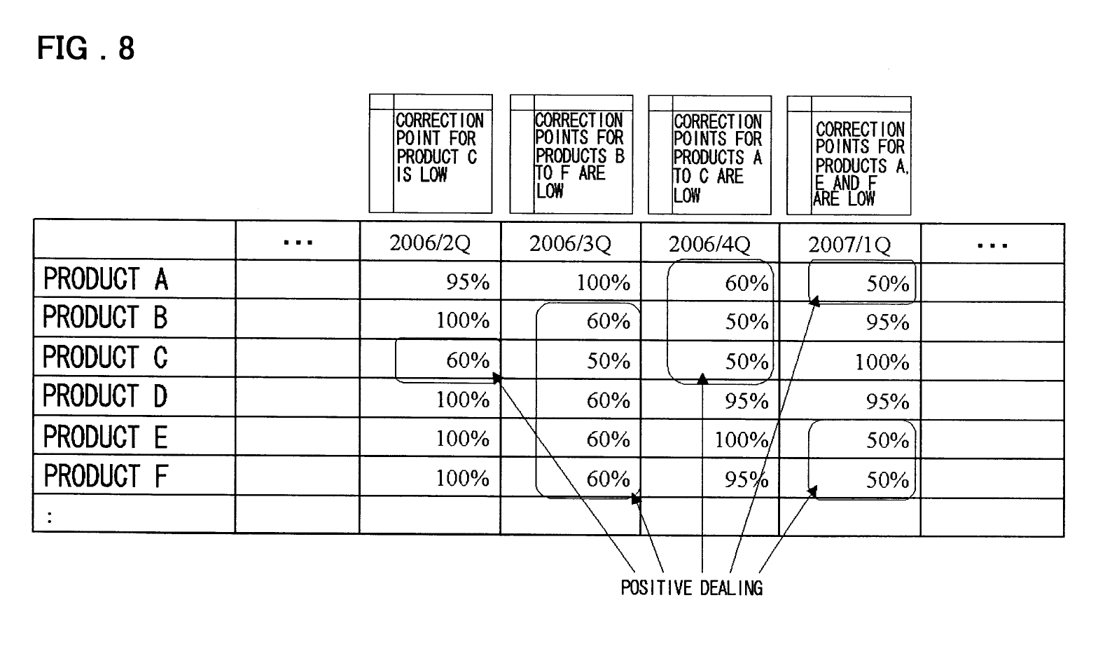

FIG. 8 depicts a table for illustrating the state of the operation on the production lines for the products A to F in the time sequence. In this table, the parts each surrounded by a solid line indicate a state where the state of operation of the production line is not busy and more positive marketing activities are desired. For example, the correction point for the product C in the table, applied to the second quarter of 2006, may be set to a smaller value in order to offer a more attractive price to the client so as to tempt the client to place a new order. By setting the correction points consistent with the operating state of the production line, in the DB for correction 42, it is possible to set the correction point to a lower value when the operating state is not busy. By so doing, the operating rate may be improved to render it possible to effectively utilize the production resources. Meanwhile, the operating state may also be stated as the ‘relative busy state’ so that it may be said that the correction point is determined in the DB for correction 42 in keeping with the ‘relative busy state’ of the production line.

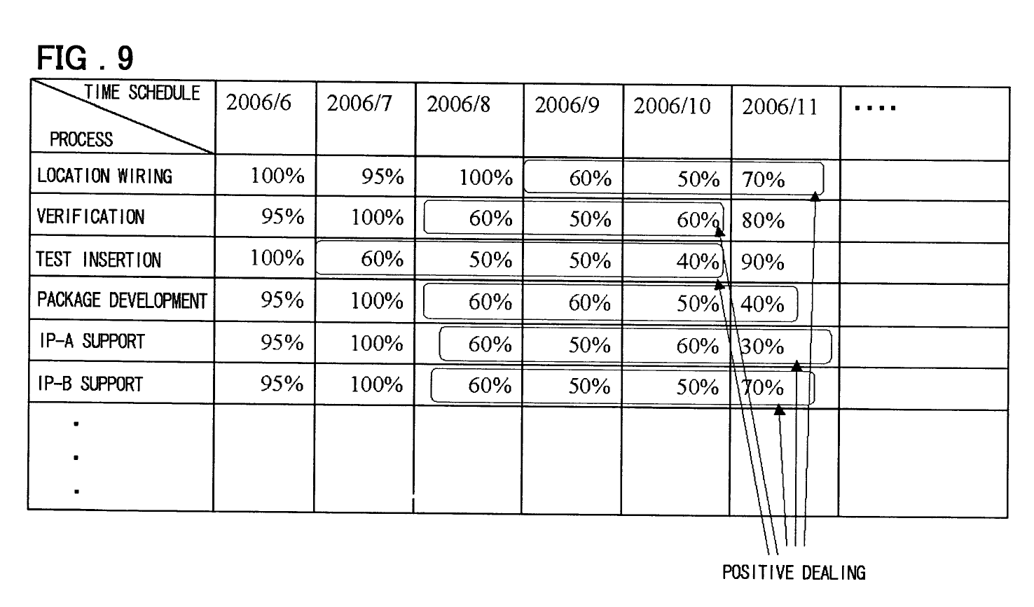

FIG. 9 depicts a table showing the non-busy state (‘relative busy state’) of development resources of products A to F in the time sequence. In the drawing, the parts each surrounded by a solid line indicate a state where there are allowances of the development resources and where the more positive marketing activities are desired. For example, by setting low correction points of the products so that the layout/wiring process will be busy for the period of September until November of 2006, it is possible to offer more attractive prices for the client in order to induce the client to place an order. By setting the correction points consistent with the ‘relative busy state’ of the designing line in the DB for correction 42, it is possible to lower the values of the correction points to make more effective utilization of the development resources.

In sum, optimum correction points may be set in keeping with the progress of the ‘relative busy state’ of the line (relative busy state of the production line or the designing line) to make more effective utilization of the vendor's resources.

By incidentally updating the correction tables, illustrated in FIGS. 3 to 6, from plural viewpoints, it becomes possible to improve the operating state of the vendor's equipment and resources in a well-balanced condition.

### Second Exemplary Embodiment

A second exemplary embodiment of the present invention, a modification of the above-described first exemplary embodiment, will now be described in detail with reference to the drawings. In the above-described first exemplary embodiment, a user dissatisfied with the result of the estimation re-enters schematics of business matters or the request specifications for re-estimation (YES of step S008 of FIG. 7). The second exemplary embodiment, now described, differs from the first exemplary embodiment in that the marketing operation supporting server 30 offers an estimate of a list style including two or more plans.

Since the present exemplary embodiment may be implemented in a constitution similar to that of the first exemplary embodiment, the following description, which is made with reference to the flowchart of FIG. 7, is centered about this point of difference.

When the client terminal 10 first accesses an automatic estimation system, offered by the marketing operation supporting server 30 (step S001), the marketing operation supporting server 30 sends a form for estimation to the client terminal 10 (step S002).

In the form for estimation of the present exemplary embodiment, the estimation list type is selected, and an item contained in the schematics of business matters or the request specifications, and changes of which cannot be tolerated, is specified.

When the client terminal 10 has entered and sent the estimation list type, schematics of business matters (dealings), the request specifications, and the importance attached to request items, contained therein, according to input items of the form for estimation (step S003), the marketing operation supporting server 30 references the DB for estimation 41 to formulate an estimate of two or more patterns (step S004). Meanwhile, in formulating the estimate of the two or more patterns, it is not necessary to meet all items requested by the user. The items other than the items, the change of which has been specifically stated to be not allowable, may be suitably changed.

The marketing operation supporting server 30 then references the tables stored in the DB for correction 42. The marketing operation supporting server 30 acquires correction points, as in the first exemplary embodiment, and executes the processing of correcting the prices of the estimation of the two or more patterns, as found in step S004 (unit prices of products and development cost) and the delivery period (step S005).

The marketing operation supporting server 30 sends to the client terminal 10 the estimate of a list style, in which the estimation data as corrected in step S005 is sorted in keeping with the estimation list type as specified by the user (step S006). The marketing operation supporting server 30 causes the same contents to be stored in the DB for estimation history 43 (step S006).

The client terminal 10 displays the list style estimate as received from the marketing operation supporting server 30 (step S007).

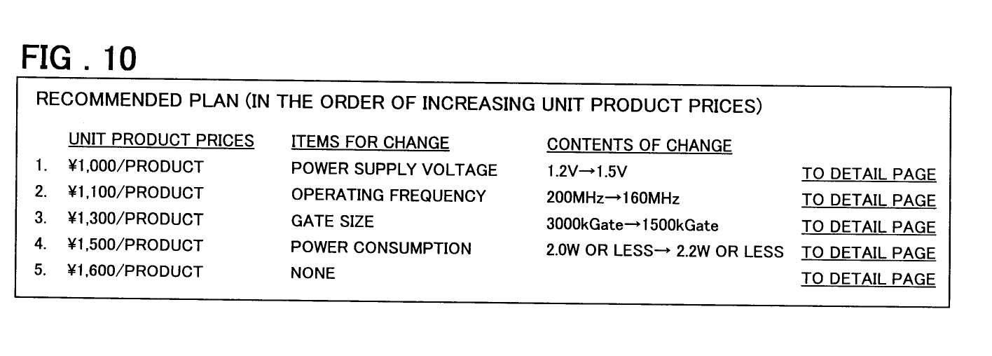

FIG. 10 depicts an example of a response picture image when the estimation list type in the order of the increasing unit product prices is selected in the estimation request. In the example of FIG. 10, plural plans of the prices, obtained on applying the correction points of the DB for correction 42 to the prices calculated using the DB for estimation 41, are enumerated in the order of the increasing prices. The contents entered in the ‘ITEMS FOR CHANGE’ and in the CONTENTS OF CHANGE’ denote changes from the request specifications as entered by the user. For example, the uppermost row denotes a proposed product where the power supply voltage is changed from 1.2V of the user's request specifications to 1.5V to yield the lowest unit product price.

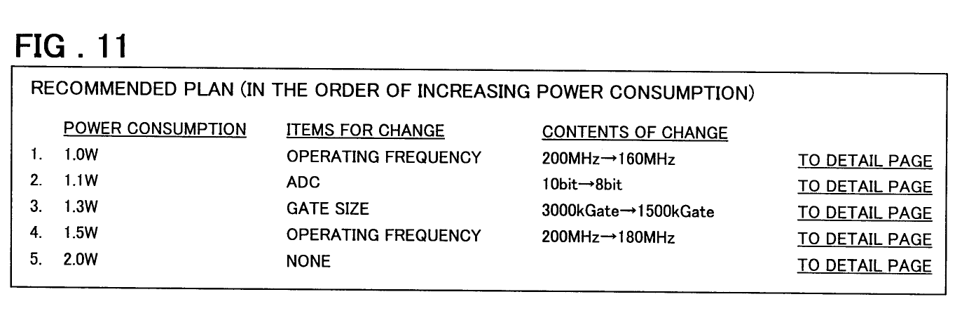

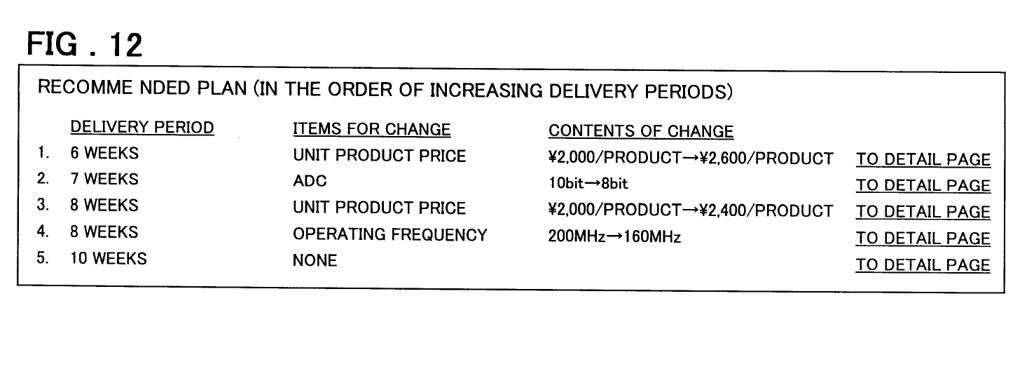

Meanwhile, there is entered ‘NONE’ in the ‘ITEMS FOR CHANGE’ for Y1,600/product on the fifth row of the recommended plan of FIG. 10. This means that the plan has not changed the client's initial request. However, there may be cases where an important item for the user, for example, the unit product price, is not satisfactory for the user. The meaning of ‘NONE’ is the same in the ‘ITEMS FOR CHANGE’ in FIGS. 11 and 12.

FIG. 11 depicts an example of a response picture image when the particular estimation list type, arranged in the order of the increasing power consumption, is selected in the estimation request. In this example, there are enumerated several plans in which, on the proviso that the power consumption cannot be changed, certain items other than those for which changes are specified to be not allowed have been changed. For example, an uppermost row offers a proposed product in which the operating frequency is changed from 200 MHz of the user's request specifications to 160 MHz to yield the lowest power consumption. In the ‘ITEMS FOR CHANGE’ in FIG. 11, ‘ADC’ is an abbreviation of an analog digital converter.

FIG. 12 shows an example of a response picture image when an estimation request was made with selection of the particular estimation list type arranged in the order of the increasing length of the delivery period. In this example, there are enumerated several plans in which, on the proviso that utmost importance is attached to the delivery period, certain items other than those for which changes are specified to be not allowed have been changed. For example, an uppermost row offers a proposed product in which, even though the unit product price becomes higher, the shortest delivery period may be realized by using a non-operating production line.

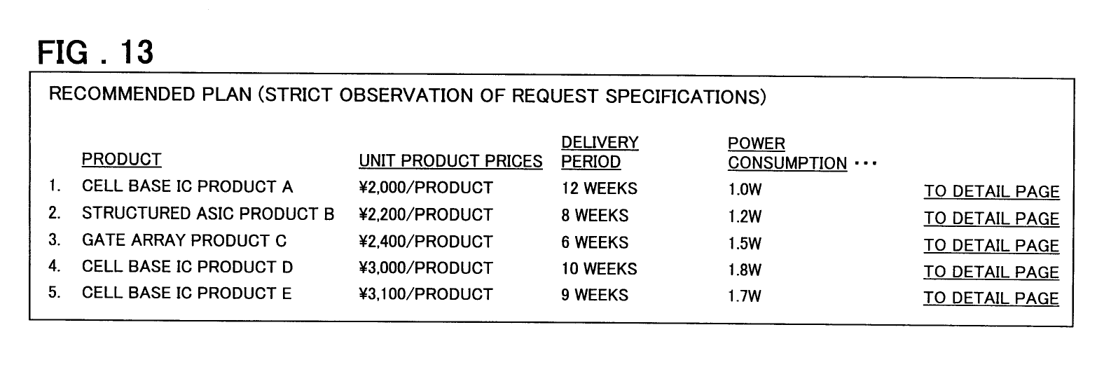

FIG. 13 shows an example of a response picture image when an estimation request was made with selection of the particular estimation list type where the requested specifications must be strictly respected. In this example, there are enumerated several product-based plans, capable of satisfying all of the request specifications, in the order of the increasing prices. The example for FIG. 13 is for a request for large production quantities and high performance. An uppermost row of the response picture image shows a proposed product by the cell-base IC, where the total cost may be suppressed. Meanwhile, in FIG. 13, product classes, such as product A, are rough product classes (or grouping) which are the same as those used in FIGS. 3 to 6. It goes without saying that finer and more specific product classes may be used, that is, specified product names may be indicated, as necessary.

If, in the present exemplary embodiment, no optimum proposals have been acquired from the estimation results, output in the list style, it is possible to obtain further estimation lists. In this case, it is necessary to change the items entered in the form for estimation and to partially correct the particular estimation list type, schematics of the business matters or the request specifications (YES in step S008).

### Third Exemplary Embodiment

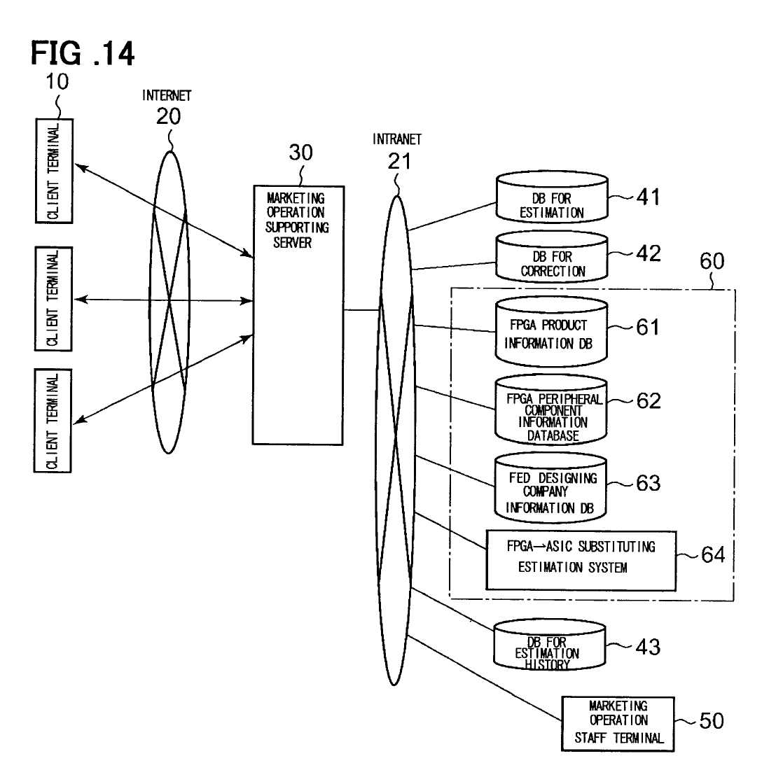

A third exemplary embodiment of the present invention is now described in detail with reference to the drawings. FIG. 14 shows the constitution of the third exemplary embodiment of the present invention. The constitution of FIG. 14 is roughly divided into a part taking charge of general ASIC estimation and a part 60 surrounded by a chain-dotted line. This part 60 is used for substitution estimation from FPGA (Field Programmable Gate Array). Meanwhile, the FPGA is, as the name implies, what may be said a sort of a gate array, and hence is a species of a custom semiconductor.

The part used for general ASIC estimation is similar to the constitution of FIG. 1, and is made up of a client terminal 10 and a marketing operation supporting server 30, both of which can be connected to the Internet 20. There are also shown a database for estimation 41, referred to below as DB for estimation, used as a basis for price estimation, a database for correction 42, referred to below as DB for correction, an estimation history database 43, referred to below as DB for estimation history, and a marketing operation staff terminal 50. The databases 41 to 43 and the marketing operation staff terminal 50 are connected to an intranet 21.

The constitution of FIG. 14 also includes, for substitution estimation from FPGA to ASIC, an FPGA product information database 61, referred to below as FPGA product information DB 61, which is a collection of the product information of the FPGA, as a target, and an FPGA peripheral component information database 62, referred to below as FPGA peripheral component information DB 62. The constitution also includes an FPGA→ASIC substituting estimation system 64, as an estimation system relevant to substitution from FPGA to ASIC, and an FED designing company information database 63, referred to below as FED designing company information DB 63. This FED designing company information DB 63 is a section that takes charge of gate level circuit designing of ASICs, that is, the designing from describing a circuit operation by RTL through formulating the circuit by logic synthesis to circuit verification by a verification tool (Front End Designing, abbreviated as FED or FED designing).

The client terminal 10 is an information processing device, such as a personal computer, capable of accessing the marketing operation supporting server 30 via the Internet. The client terminal 10 includes a browser and may enter in a form for estimation, sent from the marketing operation supporting server 30, to browse the results of the estimation.

The marketing operation supporting server 30 is an information processing device that constitutes an automatic estimation system for the custom LSI. The marketing operation supporting server sends to the client terminal 10 that accesses it a form for estimation in which to enter the schematics of business matters (dealing) and the request specifications relevant to the custom LSI. Based on the contents entered in the form for estimation, the marketing operation supporting server 30 references the DB for estimation 41 to generate and send results of the estimation which will be in keeping with the request specifications, costs (unit prices and development costs) or the delivery period (delivery period of the prototyped merchandise and that of mass-produced merchandise) as specified by the client terminal 10.

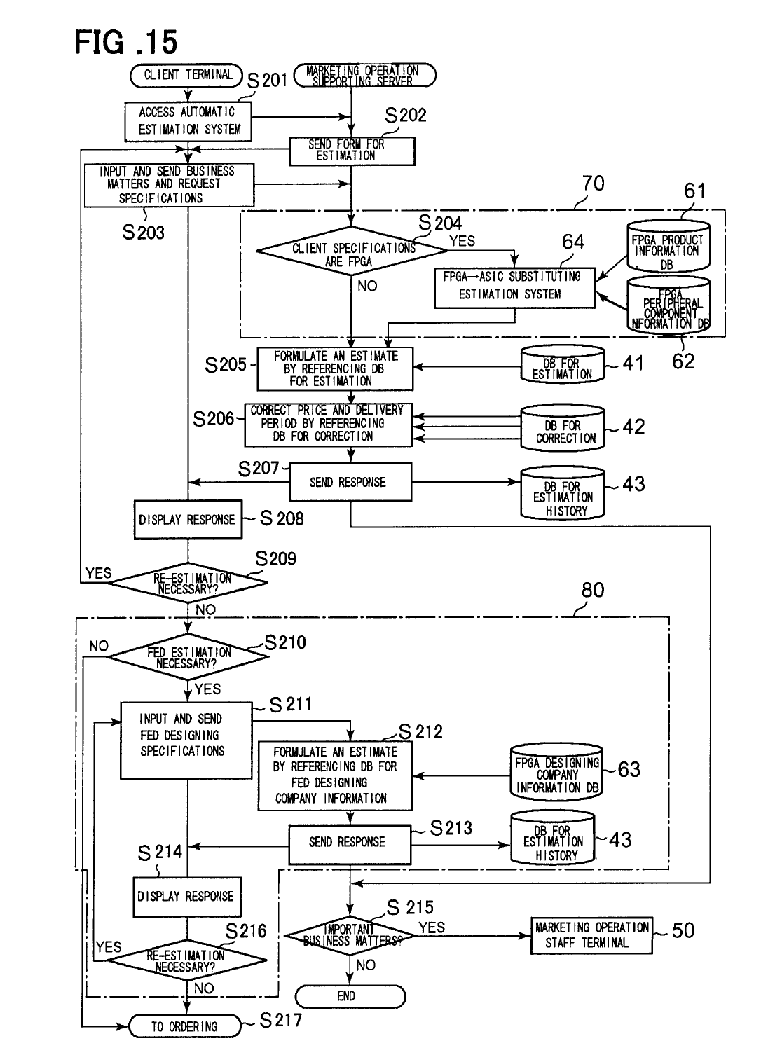

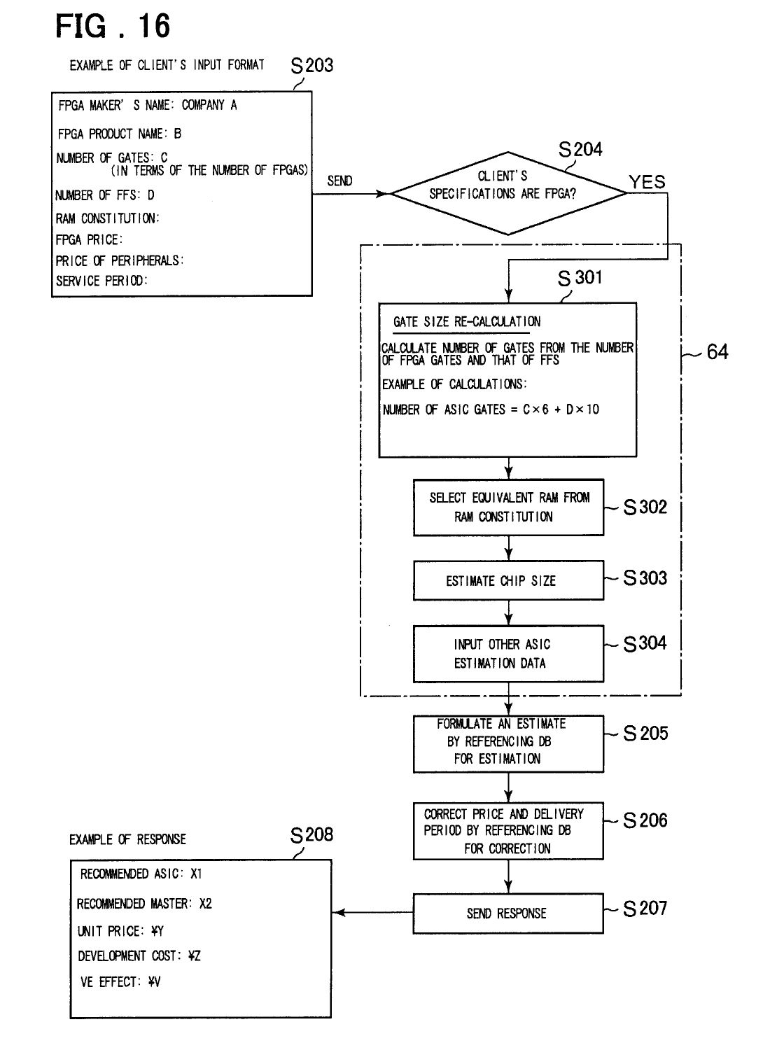

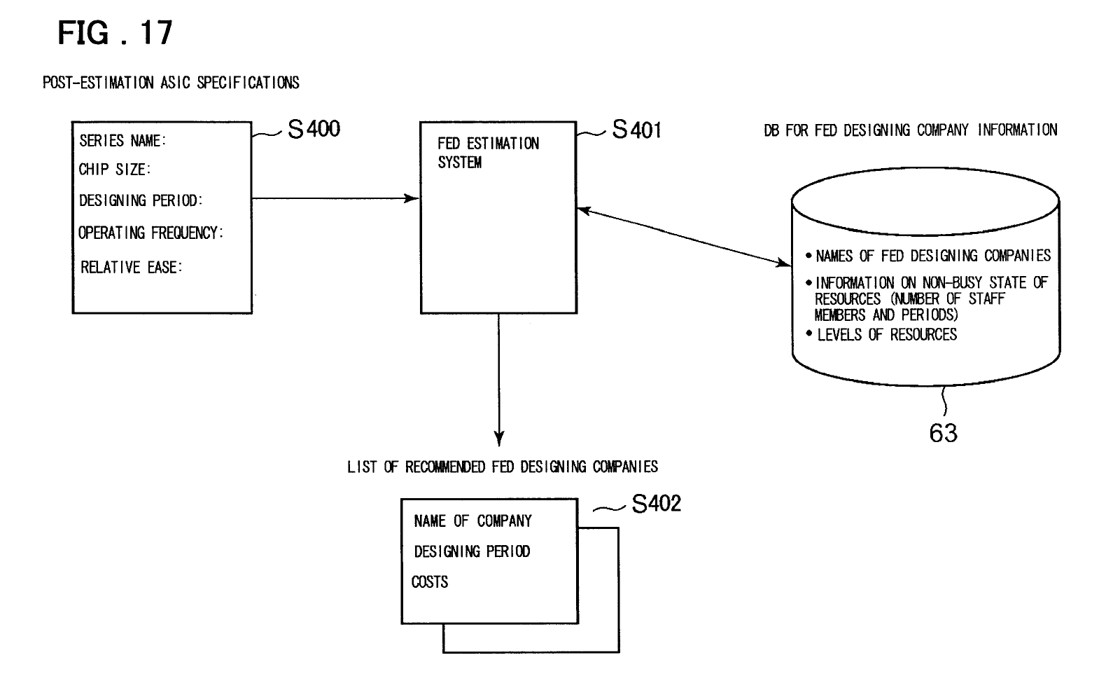

FIG. 15 depicts an overall operation of the present exemplary embodiment. The flowchart of the present exemplary embodiment appreciably differs from that of FIG. 7 in that a region delimited by a chain-dotted line 70 and a region delimited by a chain-dotted line 80 have been added to the flowchart of FIG. 7. In the former region, an inquiry is made as to whether or not the current client specifications are for FPGA (step S204) and, if the answer is affirmative, the FPGA→ASIC substituting estimation system 64 is run into operation. In the latter region, FED estimation services are rendered. FIG. 16 depicts a flowchart showing the FPGA→ASIC substitution which is a feature of the present exemplary embodiment. FIG. 16 is partially overlapped with FIG. 17 for ease in understanding and FIG. 17 depicts a schematic view for illustrating a FED estimation system. The present exemplary embodiment will now be described in order with reference to these figures.

Referring to FIG. 15, the client terminal 10 accesses an automatic estimation system provided by the marketing operation supporting server 30 (step S201). The marketing operation supporting server 30 sends a form for estimation to the client terminal 10 (step S202).

It should be noted that the client terminal 10 is an authentic client terminal authorized through the client examination. Like customary systems, the present automatic estimation system has a variety of functions for assuring system safety to eliminate illegal actions on the system operations by malignant third parties. These functions include client examination, authorization systems, firewalls, transactions by passwords and client certification which is required each time an inquiry is made. However, such is not particularly relevant to the present invention and therefore the illustration is dispensed with. It goes without saying that certification that the client terminal be an authentic client (authorization) has already been made before sending the estimation form.

If, in the client terminal 10, the user enters and sends the schematics of business matters (dealing) and the request specifications, in accordance with the input items of the form for estimation (step S203), the marketing operation supporting server 30 checks the contents of the form for estimation (step S204). Initially, the marketing operation supporting server 30 checks whether or not the client specifications are those of the FPGA, based on whether or not the name of the FPGA maker and the FPGA product name are present in the client's input format. A specified example of how this check is made will be described subsequently. When the client specifications are those of the FPGA, the server proceeds to the FPGA→ASIC substituting estimation system 64, as later described. When the client specifications are not those of the FPGA, the server references the DB for estimation 41 to formulate an estimate (step S205).

Referring to FIG. 16, the FPGA→ASIC substitution flowchart is now described. Meanwhile, the same steps as those shown in FIG. 15 are described with the use of the same symbols as those of FIG. 15.

In a step of inputting and sending the schematics of business matters and the request information (step S203 of FIG. 15), the client requesting an estimate concerning the substitution from FPGA to ASIC sends the information, shown in an example of a client input format (S203) of FIG. 16, as described previously.

This information may be exemplified by the name of the FPGA maker, name of the FPGA product, the number of gates and flipflips, abbreviated to FFs, RAM configuration, FPGA price, price of peripherals, and the period for use. These have been entered in accordance with the input format sent to the client with the form for estimation in step S202 of FIG. 15.

It is noted that there is contained, in the form for estimation to the client, an inquiry, not shown, as to whether or not the substitution from the FPGA to the ASIC is to be made. When the client's response is affirmative YES, an input form at is changed to an input form at shown for example in FIG. 16.

In the next step S204, the marketing operation supporting server 30 decides on whether or not the client's specifications are those for the FPGA. This decision may be given by checking the input form type, sent as described above, and the contents of the input form at. Since FIG. 16 presupposes that the client specifications are those for FPGA, the case for NO in step S204 is not shown. In FIG. 16, focused on the description of the processing steps, none of the reference databases 61, 62, 41, 42 and 43, shown in FIG. 15, is shown. However, it goes without saying that reference is being made to these databases as appropriate.

Reverting to FIG. 16, the concrete processing contents of the substituting estimation system 64 are indicated by steps S301 to S304 encircled by a chain-dotted line 70. On receipt of the input format, the substituting estimation system 64 executes gate size conversion in step S301. This gate size conversion or re-calculation may be accomplished by finding an approximate value of the gate size from the number of the gates and FFs of the FPGA. Only by way of illustration, the number of gates of the ASIC may be found by (number of gates of the ASIC)=(FPGA-unit number of gates)×6+number of FFs of FPGA×10. Of course, this approximation is merely illustrative and a large variety of detailed operations may be used to perform gate size approximation depending on the precision in estimation as requested by the client.

Next, in step S302, the substituting estimation system 64 selects an equivalent RAM based on the constitution of the RAM. Further, in step S303, the substituting estimation system 64 estimates the chip size and, in step S304, the substituting estimation system 64 acquires other data for ASIC estimation. This step S304 may be dispensed with depending on the size of the FPGA to be estimated. This sets data for ASIC estimation in order.

It is noted that the information stated in the client input format, introduced at the beginning part of the description with reference to FIG. 16, is merely illustrative. It is possible to provide a detailed client input format, depending on the gate size, and to request the client to make entries into this input format. This may enrich necessary other data for ASIC estimation to raise the precision in the estimation.

The substituting estimation system 64 then proceeds to a step of referencing the DB for estimation for ASIC and of formulating the estimation (step S205). Here, the DB for estimation 41 is used. In this DB for estimation 41, there are stored, in addition to various data concerning product designing and costs, data on the load on a development section (or sections) and data on the operating states of the production line, thus making it possible to find out the delivery period as well. Further, the DB for correction 42 is referenced to correct the price and/or the delivery period (step S206). The contents of the DB for correction 42 and the method for referencing the contents are the same as those described with reference to the first exemplary embodiment and hence are not described here to avoid redundancy. It is now possible to send a response (step S207).

The crucial goal of the estimation employing the substituting estimation system 64 is to offer a cost merit, resulting from the substitution, that is, the VE (Value Engineering) effect to the client. Hence, the amount of the VE effect is indicated, in addition to the recommended ASIC, recommended master, unit price and the development cost in the display of the response of the estimation, as shown in a response example (step S208). The approximate amount of the VE effect may be found, as an example, as a difference of <the unit price of the ASIC product×quantity used of the ASIC products+development cost>versus<the unit price of the FPGA×quantity used of the FPGA products>.

The result found as described above, that is, a written estimate, an example of which is shown at a step S208, is, after all, an example of the estimate, and may be varied in many ways, depending on e.g. the client's requests.

A plural number of different types of tables, such as tables for correcting unit prices of products, tables for correcting the developing cost, or tables for correcting the response delivery period, are stored in the DB for correction 42. Since the way in which these tables are used is similar to that described in connection with the first exemplary embodiment, it is not described here to avoid redundancy. Meanwhile, the ‘products’ in the table for correcting unit prices of products denote the products of ASIC in case of substitution of ASIC for FPGA. The same applies for other tables for correction as well. In a client input format of FIG. 16, there is no cell to enter the client's name. However, since the estimate request process is commenced only after specifying and checking for client's authenticity, the client name may be checked by the marketing operation supporting server 30.

The process for correction and strategic price setting, based on the depreciation rate of the production line, are also the same as those described in connection with the first exemplary embodiment, and hence are not described here in detail.

The marketing operation staff terminal 50 is an information processing device, such as a personal computer, owned by a marketing operation staff member who receives a notification of business matters (dealings), a business meeting for which need to be proposed from the marketing operation supporting server 30. Also, the contents of the response to the client recorded in the estimation history DB 43 are attached to the notification of business matters that are in need of business meetings, as will be described subsequently.

The way the prices and the delivery period are corrected from the strategic standpoint, using various correction points, is also similar to that described in connection with the first exemplary embodiment. Hence the detailed description therefor is also dispensed with.

There may be a case where, from the perspective of the client, there is no cost merit resulting from the price correction, in other words, the cost becomes lower for the client in case of continuing to purchase the FPGA. In such case, the VE effect, shown in the example of the response in step S208 of FIG. 16, is negative, and expressed by red-letters. As a matter of course, it may be presumed that the client will refrain from purchasing the ASIC, which is unavoidable if the client is to evade the risk. Meanwhile, even in such case, a decision on whether or not the business matters of interest are important is to be given after sending the response in step S207. If the business matters of interest are determined to be important, the information is immediately transmitted to the marketing operation staff terminal 50, so that the marketing operation staff member may contact the client (step S215). For this decision, the criteria based on which to give decision on whether or not the business matters of interest are important are input to the computer system at the outset, and updated from, e.g,. the supervisor, thus ensuring a timely decision.

To prevent a break-even situation or an excessively high offer amount, resulting from excessive price correction, it is also desirable to set the upper and lower limit values (range) of the values of price correction. This is substantially as described in connection with the first exemplary embodiment and hence is not here described in detail.

The client terminal 10 displays the contents of the estimate received from the marketing operation supporting server 30 (step S208). In case the user is satisfied with the results of the estimation, an order is placed with their contents. An E-mail or facsimile may be used in placing the order, however, if the marketing operation supporting server 30 is provided with a separate order receiving function, the order may be placed from the client terminal 10, using this separate function.

If the user is not satisfied with the contents of the estimation, it is possible for the user to change the entries in the form for estimation again to partially correct the schematics of the business matters (dealings) or the request specifications in order to obtain a second estimate (YES of step S209). Since the second response is corrected, by referencing the DB for correction 42, the second response has also been adjusted in keeping with the situation or the strategic guideline on the part of the custom LSI vendor. In this second estimate, it is of course possible to make the estimation disclosed in the second exemplary embodiment, that is, the estimation based on one of plural plans and on revision, e.g., of the functions and resulting correction of the product price (unit price).

If the contents of the estimation in the response sent in step S207 meet the conditions as set in advance by the vendor, as when the contents indicate big business matters or relate to an inquiry concerning a key sale promotion product, the marketing operation supporting server 30 notifies the marketing operation staff terminal 50 of such effect and the contents of the estimation as offered (step S215). It is now possible for the marketing operation staff to confirm the contents of the estimation as notified and to proceed to positive order receiving operations. Meanwhile, the criteria for judgment as to whether or not the business matters in question are important may, of course, be corrected as necessary and stored in the marketing operation supporting server 30.

In this manner, the correction tables may incidentally be updated from various perspectives, as described in the first exemplary embodiment, thereby improving the equipment and the operating status of the entire resources on the side of the vendor. It is also possible to utilize the estimation described in connection with the second exemplary embodiment.

If the client is satisfied with the contents of the ASIC estimation, it is necessary to proceed to ASIC gate level circuit designing (FED). However, some clients do not have the ability to perform this designing. For supporting these clients, a supporting function of introducing a FED designing section, that is, an FED designing organization, may be intimated from the marketing operation supporting server 30 via intranet 21 to the client. This will now be described in detail with reference to FIGS. 15 and 17.

On reverting to step S210 of FIG. 15, the marketing operation supporting server 30 asks the client as to whether or not FED estimation is to be made. If the client's response is negative NO (estimation unnecessary), an order is placed and the estimation system comes to a close (step S217). If the client's response is affirmative YES (estimation necessary), the marketing operation supporting server 30 proceeds to enter and send FED designing specifications (step S211). If the FED designing specifications have been sent, the marketing operation supporting server 30 proceeds to reference the DB for FED designing company information and to prepare an estimation (step S212), to help formulate an estimation by referencing the DB for FED designing company information 63. A specified example will now be described with reference to FIG. 17.

FIG. 17 depicts a schematic view showing a specified example of formulation of an FED estimate in its entirety. A typical example of as-estimated ASIC specifications, sent in step S211 of FIG. 16, is briefly shown in step S400. Here, the information needed for FED design estimation, including series name, chip size, design period (design delivery period), operating frequency and relative ease, is entered. The FED estimation system references the DB for FPGA peripheral component information 63, based on the information needed for this FED design estimation. The FED estimation system verifies the information on the non-busy state of the designing resources, on the level of the designing resources and on the estimation by the client, from the FED designing company information DB, to get a list of optimum recommendable designing companies (step S402).

The FED estimation system sends, as response, the list of optimum recommendable designing companies, obtained in the above step S402 (step S213 of FIG. 16). This response is displayed on a client's screen (step S214). Although details of the response display example are not shown, the information including the company's name, design period or the cost, for example, is displayed. The level of resources and past records of the respective companies may also be displayed in addition to the above information. Of course, the contact address, for example, is included in the company's name. The recommended information for plural companies may also be indicated for the client to select one of these companies. The client checks the contents and, if re-estimation is unnecessary, proceeds to placing an order (step S216). If re-estimation is needed, the system reverts to step S211. In this case, too, it is checked, after sending the response (step S213), whether or not the business matters on hand are important (step S215). If the business matters on hand are important, such effect is displayed at the marketing operation staff terminal 50. The marketing operation staff member then proceeds to follow-up where necessary.

The above completes the sequence of operations. The present third exemplary embodiment has the following meritorious effect, in addition to those of the first and second exemplary embodiments. That is, a response request for substitution from one product type to another of the custom semiconductor, such as that from FPGA to ASIC, may promptly be coped with. The pull type business, which will take the place of the conventional push type business of the substitution proposal type, may be promoted smoothly. The VE effect, that is, how much cost merit may be derived as compared to the conventional FPGA, may be demonstrated for the client in an easy-to-see manner. If the client is unable to design the FED of ASIC for himself, the client's labor in searching for a FED design company to have the company perform the estimation may be dispensed with, thus sparing the client's labor to make for ease in ordering.

Although the preferred exemplary embodiments of the present invention have been described in the foregoing, various changes may, of course, be made without departing from the purport of the invention that correction points for the contents of items not directly influencing the prevailing price (correction items) are used to allow the estimation to more flexibly conform to practical conditions,. For example, although the foregoing exemplary embodiments relate to estimation of the custom semiconductor, the present invention may also be applied to estimation of other products where surrounding conditions are similar and conditions such as prices or the delivery period are to be changed more flexibly. The disclosed elements may further be susceptible to a large variety of combinations, substitutions or selections without departing from the claims.

In the above exemplary embodiments, it is presupposed that the client directly requests estimates using the client terminal 10. However, it is of course possible for the vendor's marketing operation staff member to request the marketing operation supporting server 30 to make the estimation in the course of his/her marketing operation activities.

It should be noted that merely preferred examples are shown of data stored in the DB for correction 42. For example, the constitution of the tables of FIGS. 3 to 6 may suitably be changed as necessary, such that tables or table items may be added or deleted as necessary.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A marketing operation supporting server for automatically returning a response to an estimation request from a client terminal, comprising:
a database for estimation that calculates a prevailing price based at least on specifications and quantities of a product; and
a database for correction having set therein correction points associated with contents of a plurality of correction items not influencing said prevailing price; said correction items being items of attributes proper to matters relating to said estimation request; wherein
a response for estimation is made at a special price which has corrected said prevailing price using correction points associated with at least two of said correction items.

2. The marketing operation supporting server according to claim 1 wherein
said estimation request executes substitution from one custom semiconductor product type to another custom semiconductor product type.

3. The marketing operation supporting server according to claim 1 wherein, in making estimation to said other custom semiconductor product type, the cost reducing effect for a client, attendant on change from said one custom semiconductor product type to said other custom semiconductor product type, is automatically offered.

4. The marketing operation supporting server according to claim 1, further comprising:
a database of detailed designing sections that executes detailed designing of said other custom semiconductor product type; wherein
at least one of said detailed designing sections is offered responsive to a request for introducing a detailed designing section from said client terminal.

5. The marketing operation supporting server according to claim 1 wherein said database for correction has set therein a depreciation rate of a production line associated with a custom semiconductor product type, and a correction point conforming to said depreciation rate; and wherein
correction is made by said correction point conforming to said depreciation rate of a production line associated with a custom semiconductor product type relating to the request for estimation.

6. The marketing operation supporting server according to claim 1 wherein said database for correction has set therein a relative busy state of a designing line associated with a custom semiconductor product type, and a correction point conforming to said relative busy state; and wherein
correction is made by said correction point conforming to said relative busy state of a designing line associated with a custom semiconductor product type relating to the request for estimation.

7. The marketing operation supporting server according to claim 1 wherein said database for correction has set therein a plurality of correction items and correction points therefor; and wherein
if at least one of said correction points exceeds a preset threshold value, only correction by said correction point is done to calculate said special price.

8. The marketing operation supporting server according to claim 1 wherein a limit value of pricing correction by said database for correction is set.

9. The marketing operation supporting server according to claim 1 wherein
relative strictness in respecting a preset one of said items may be designated in said estimation request;
the correction points on said database for correction are set so that a price offered will be cheaper as said relative strictness in respecting said preset item becomes lower; and
correction is made with the relative strictness requested in respecting said preset item.

10. The marketing operation supporting server according to claim 1 further comprising:
means for accepting an input of an upper limit of a presupposed price at said estimation request; wherein
if, after referencing said database for estimation and said database for correction, a response for estimation, which will satisfy the request specifications designated in said request for estimation and said upper limit of said presupposed price, cannot be returned, re-entries in one or more items that are specified in said request for estimation and that may be made more lenient are requested to proceed to a re-response.

11. The marketing operation supporting server according to claim 1 further comprising:
means for accepting inputting of an upper limit of a presupposed price and inputting of the relative importance of an item included in said request for estimation; wherein
a plurality of responses for estimation, in which items with high relative importance have been respected and items with low relative importance have been changed, are formulated, by referencing to said database for estimation and to said database for correction.

12. The marketing operation supporting server according to claim 1 wherein, for said request for estimation, said one custom semiconductor product type and said other custom semiconductor product type comprise a FPGA and an ASIC, respectively.

13. The marketing operation supporting server according to claim 1, further comprising:
business matter extraction means for extracting the request for estimation, that is to be individual business matters, based on the contents of said request for estimation, and for notifying a preset terminal of a staff member in charge of said business matters of the extracted request for estimation along with the contents of the response offered to said client terminal.

14. The marketing operation supporting server according to claim 1 wherein
correction points that are in keeping with client classification that is based on the importance attached to clients, are set in said database for correction; and
correction is made using correction points of the client class under which comes the client who has made said request for estimation, whereby a price differentiated from the price for other client classes may be offered.

15. The marketing operation supporting server according to claim 1 wherein
correction points that are in keeping with strategic importance of product types are set in said database for price correction; and
a price adjusted using the correction point of the product type in said request for estimation may be offered.

16. The marketing operation supporting server according to claim 1 wherein said database for correction includes a table for correcting a unit product price, having stored therein correction points referenced at correction of a product unit price, a table for correcting the development cost, having stored therein correction points referenced at correction of the product development cost, and a table for correcting a response delivery period, having stored therein correction points referenced at correction of the response delivery period; and wherein
correction is made for the matters relating to said request for estimation, in accordance with the correction points as found from said tables, to correct the unit product price, the product development cost and the delivery period to enable a response to be returned.

17. A program that may be executed by a marketing operation supporting server provided on a network, said marketing operation supporting server returning an automatic response to a request for estimation from a client terminal; said program comprising:
processing of referencing a database for estimation, based on contents entered with said request for estimation to calculate a prevailing price; and
processing of referencing a database for correction having set therein correction points associated with contents of a plurality of correction items not influencing said prevailing price; said correction items being items of attributes proper to matters relating to said estimation request; extracting correction points associated with at least two of said correction items; and correcting said prevailing price based on the extracted correction points; and
processing of sending a response for estimation at an as-corrected special price to said client terminal.

18. A method for returning a response for estimation by a marketing operation supporting server provided on a network; said marketing operation supporting server automatically returning a response for estimation to a request for estimation from a client terminal; said method comprising:
a step of said marketing operation supporting server referencing a database for estimation, based on contents entered with said request for estimation for calculating a prevailing price;
a step of said marketing operation supporting server referencing a database for correction having set therein correction points associated with contents of a plurality of correction items not influencing said prevailing price; said correction items being items of attributes proper to matters relating to said estimation request; extracting correction points associated with at least two of said correction items; and correcting said prevailing price based on the extracted correction points; and
a step of said marketing operation supporting server sending a response for estimation at an as-corrected special price to said client terminal.
